(19) United States
(12) Patent Application Publication
(10) Pub. No.: US 2006/0078731 A1
(43) Pub. Date: Apr. 13, 2006

(54) Wire resistant to degradation caused by partial discharges

(76) Inventors: Mario Celio Contin, Jaragua do Sul - SC (BR); Vicente Koch, Jaragua do Sul - SC (BR); Angelita de Araujo, Jaragua do Sul -SC (BR)

Correspondence Address: FLESHNER & KIM, LLP, P.O. BOX 221200, CHANTILLY, VA, 20153, US

(21) Appl. No.: 10/959,323

(22) Filed: Oct. 7, 2004

(30) Foreign Application Priority Data
Oct. 7, 2004 (BR) PI 0303953-6

(51) Int. Cl. B32B 27/00

(52) U.S. Cl. 428/375

(57) ABSTRACT

A wire resistant to degradation caused by partial discharges has an insulation coating that includes a first later of an organic Polyether Imide (PEI) adjacent the wire and a second layer of an organic PolyAmide Imide (PAI) which surrounds the first layer.

This report deals with an invention privilege patent with regard to electrical conductors (wires) that are particularly resistant to degradation caused by partial discharges (Corona Effect). This patent request is particularly related to the type of insulation provided in such conductors, of which can be applied on windings of motors fed by static frequency converters, which are commercially called frequency invertors.

As it is of common knowledge of technical experts in the field, there presently exists, in function of the relatively recent application of motors fed by frequency invertors, a great problem to overcome and which is related to the significant reduction of useful life of motors in function of the high degradation rate caused by Partial Discharges, which occur in an insulating system, more specifically, over the interior wires of the windings of these motors.

The occurrence of these Partial Discharges has increased over the last years due to the great development of potential electronics, which has created very fast activation devices (connection and disconnection), such as IGBT (Insulated Gate Bipolar Transistor) transistors.

The association of these devices with motors whose feeder cables' length is relatively long, has caused the high rates of Partial Discharges in function of the appearance of wave reflections, a very common phenomenon to transmission lines.

Waves fronts (pulses) originate from the semi-conductor devices used in the PWM (Pulse Width Modulation) type frequency invertors, which switch very quickly to attend the necessary commutations for a better fundamental harmonic voltage formation.

These wave fronts are high frequency components that are reflected on the input (terminals) of the motors, causing voltage build-ups in the order of 3 times or more, relative to the effective nominal voltage of the feeder network.

This reflection is also caused in function of the high impedances, which are characteristic of induction motors, if compared with the equivalent impedances, which are characteristic of feeder cables (between the inverter and the motor).

Due to the great change in the impedance value, when the signal passes from the cable to the interior of the motor, the incident wave reflection occurs; this is reflected and overlaps itself, creating amplitude in the terminals of the motors that can reach twice or more, relative to the amplitude of the incident pulse (wave front).

With the occurrence of Partial Discharges, an accelerated degradation originates that can lead the motors towards premature burn. However, it is unquestionable that the application of motors with frequency invertors brings innumerous advantages, which cannot be done without, considering principally the high degree of development in which these devices are found today.

Partial Discharges always begin with the phenomenon known as Corona Effect, which consists of the breaking of the dielectrical rigidity of the air from the internal layers that surround the wires in the insulation systems.

These air layers in the interior of the insulation system appear since the filling up of the spaces between the wires is not complete on the part of the impregnation material, in industrial processes.

Even in the most advanced processes, such as VPI (Vacuum Pressure Impregnation), widely used in high voltage rotating machines, this filling up is not total, with the occurrence of Partial Discharges with some intensity. After having broken the dielectrical Rigidity of the air (Corona effect), due to the highly ionizing effects caused by the charges (electrons) that collide with the walls of solid insulations, additional charges are created, many times called spatial charges, which adhere to the initial electrical current of discharges (corona effect) and increasing its value, passing to constitute the final current of Partial Discharges, thus simply known as Partial Discharges.

For the manufacture of motors fed by frequency invertors, it is very important that the wires used in the windings have the insulating layers that constitute its insulation system, sufficiently flexible, wherein during the mechanized (automated) manufacture, some mechanical stretching of these wires always happens.

For electrical motors and most especially for those from serial manufacture with high productive scale, it is very important the use of mechanized (automated) processes that allow the attainment of better indexes of productivity and consequently better indexes of competitiveness.

Some solutions can be adopted to eliminate or attenuate these effects, such as the use of wires with insulation coverings composed of inorganic materials highly resistant to Partial Discharges, such as Mica and Fiberglass and the use of electrostatic shields such as Metallic Oxides (Titanium, Chromium, etc.).

These solutions can even include the use of systems and processes with preformed reels instead of reels for random windings, widely used in low voltage mass-produced motors.

The use of attenuating filters, such as Charge Reactors on the output of frequency invertors, RC systems on the input of motors or RLC systems on the output of invertors are solutions that can be adopted.

The solutions described above, in a general way, can mean a relatively large increase in costs, bringing into evidence a great difficulty for the composition of prices that attend to this application.

In the face of the questions that involve the applications of motors fed by frequency invertors, the phenomena that cause the limitations relative to the useful life (durability) and the questions relative to the corresponding costs, impose the need of search for better solutions.

Thus, as it is, the material in which this present invention privilege patent is founded, was developed, to which is proposed a solution where a whole range of gages of wires is created especially developed to more significantly resist the ionizing attack of Partial Discharges, thus allowing the production of wires that can be used in the windings of motors fed by Static Frequency Converters, also commercially and simply called as Frequency Invertors.

The presently treated patent consists in the provision of conductor wires (copper or aluminum) with insulation coverings produced with organic layered PEI (Polyether Imide) and PAI (PolyAmide Imide) materials especially determined to increase (maximize) the resistance to degradation caused by the effects of Partial Discharges.

It is also the objective of this invention patent to provide conductor wires with Organic insulation coverings which are more resistant to degradation when subjected to exposure (attack) caused by Partial Discharges.

This patent will be particularly described in detail with reference to the designs related below, in which:

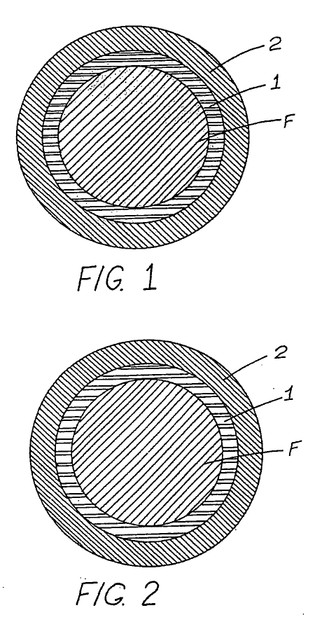

FIG. 1 illustrates a cross section view of a wire produced according to this patent, where the layers that form an insulating wall (covering), for Grade 2 geometrical classification, are retracted; and

FIG. 2 illustrates a cross section view of a wire produced according to this present patent, where the layers that form the insulating wall (covering), for Grade 3 geometrical classification, are retracted.

The patent in question foresees the use of Copper or Aluminum conductor wires, taking into consideration all the gages that comprise the complete range for the use of the wires in electrical devices (motors, transformers, contactors, reactors, etc.).

This patent includes wires with insulation coverings with total dimensions classified as Grade 2 and Grade 3, in agreement with the NEMA MW1000 norms or ISO 60317.

The insulation coverings of the wires are composed of two distinct layers, wherein the first layer (laid down first over the wire) composed of organic PEI (Polyether Imide) material and the second layer set down over the wire after the first layer, composed of organic PAI (PolyAmide Imide) material.

In FIGS. 1 and 2, the wire, as it is properly called, is indicated by the reference F, while the first layer is indicated by the numeric reference 1 and the second layer is indicated by the numeric reference 2.

In agreement with what is illustrated in FIG. 1, the composition of the covering of wire F with total dimensions for Grade 2, is equivalent to the following: the first layer 1 shows a thickness measurement that is equivalent to a range from 30 to 45% of the total thickness of the insulating wall of wire F; and the second layer 2 shows a thickness measurement that is equivalent to a range from 55 to 70% of the total thickness of the insulating wall of wire F.

With relation to what is illustrated in FIG. 2, the composition of the covering of wire F with total dimensions for Grade 3, is equivalent to the following: the first layer 1 shows a thickness measurement that is equivalent to a range from 20 to 45% of the total thickness of the insulating wall of wire F; and the second layer 2 shows a thickness measurement that is equivalent to a range of 55 to 80% of the total thickness of the insulating wall of wire F.

Within the context as described above, some possible variations in the average nominal values of the geometrical proportions of the insulation layers of wire F are shown, that is, the average values of 37.5% for the first layer 1 and 62.5% for the second layer 2 in Grade 2 wires F and the average values of 32.5% for the first layer 1 and 67.5% for the second layer 2 in Grade 3 wires F can vary over or under in function of the constructive processes, wherein such variation, if it occurs, will be covered by the scope of the material presently claimed.

1-3. (canceled)

4. A wire resistant to degradation caused by partial discharges, comprising:
a core formed of an electrically conductive material; and
an insulator surrounding the core, wherein the insulator comprises:
a first insulating layer immediately adjacent the core and formed of an organic polyether imide, wherein the first insulating layer has a thickness that is between approximately 30% and approximately 45% of a total thickness of the insulator; and
a second insulating layer that surrounds the first insulating layer and that is formed of an organic polyamide imide, wherein the second insulating layer has a thickness that is between approximately 70% and approximately 55% of the total thickness of the insulator.

5. The wire of claim 4, wherein the first insulating layer has a thickness that is between approximately 30% and approximately 35% of a total thickness of the insulator; and wherein the second insulating layer has a thickness that is between approximately 70% and approximately 65% of the total thickness of the insulator.

6. The wire of claim 4, wherein the first insulating layer has a thickness that is between approximately 40% and approximately 45% of a total thickness of the insulator; and wherein the second insulating layer has a thickness that is between approximately 60% and approximately 55% of the total thickness of the insulator.

7. The wire of claim 4, wherein the first and second insulating layers do not include any inorganic materials.

8. The wire of claim 4, wherein the first and second insulating layers do not include any metallic oxide compounds.

9. A wire resistant to degradation caused by partial discharges, comprising:
a core formed of an electrically conductive material; and
an insulator surrounding the core, wherein the insulator comprises:
a first insulating layer immediately adjacent the core and formed of an organic polyether imide, wherein the first insulating layer has a thickness that is between approximately 20% and approximately 45% of a total thickness of the insulator; and
a second insulating layer that surrounds the first insulating layer and that is formed of an organic polyamide imide, wherein the second insulating layer has a thickness that is between approximately 80% and approximately 55% of the total thickness of the insulator.

10. The wire of claim 9, wherein the first insulating layer has a thickness that is between approximately 20% and approximately 30% of a total thickness of the insulator; and wherein the second insulating layer has a thickness that is between approximately 80% and approximately 70% of the total thickness of the insulator.

11. The wire of claim 9, wherein the first insulating layer has a thickness that is between approximately 40% and approximately 45% of a total thickness of the insulator; and wherein the second insulating layer has a thickness that is between approximately 60% and approximately 55% of the total thickness of the insulator.

12. The wire of claim 9, wherein the first and second insulating layers do not include any inorganic materials.

13. The wire of claim 9, wherein the first and second insulating layers do not include any metallic oxide compounds.

14. A wire resistant to degradation caused by partial discharges, comprising:
a core formed of an electrically conductive material; and
an insulator surrounding the core, wherein the insulator comprises:
a first insulating layer immediately adjacent the core which consists essentially of an organic polyether imide; and
a second insulating layer that surrounds the first insulating layer and that consists essentially of an organic polyamide imide.

15. The wire of claim 14, wherein the first insulating layer and the second insulating layer do not include any inorganic materials.

16. The wire of claim 15, wherein the first insulating layer and the second insulating layer do not include any metallic oxides.

17. The wire of claim 14, wherein the first insulating layer and the second insulating layer do not include any metallic oxides.

18. The wire of claim 14, wherein the first insulating layer wherein the first insulating layer has a thickness that is between approximately 20% and approximately 45% of a total thickness of the insulator, and wherein the second insulating layer has a thickness that is between approximately 80% and approximately 55% of the total thickness of the insulator.

19. The wire of claim 18, wherein the first insulating layer has a thickness that is between approximately 30% to approximately 45% of the thickness of the insulator, and wherein the second insulating layer has a thickness that is between approximately 70% and approximately 55% of the thickness of the insulator.
